(19) United States
(12) Patent Application Publication
(10) Pub. No.: US 2018/0250838 A2
(43) Pub. Date: Sep. 6, 2018

(54) CUTTING BLADE

(71) Applicant: MCPHERSON'S HOUSEWARES IP PTY LTD, Kingsgrove, New South Wales (AU)

(72) Inventor: Mark James Henry, Dijon (FR)

(21) Appl. No.: 15/113,289

(22) PCT Filed: Jan. 22, 2015
(86) PCT No.: PCT/AU2015/000036

§ 371 Date: Jul. 21, 2016

Related U.S. Application Data
(60) Provisional application No. 61/930,195, filed on Jan. 22, 2014.

(51) Int. Cl. B26B 9/00; B21K 11/02

(52) U.S. Cl. CPC B26B 9/00; B21K 11/02

(57) ABSTRACT

The present invention relates to a cutting blade such as a kitchen knife blade. The cutting blade comprises a cutting edge, a spine and opposite side surfaces. A tapered portion of the blade extends longitudinally and adjacent to the cutting edge in which a thickness of the blade defined as a transverse distance between the opposite side surfaces tapers towards the cutting edge. The cutting blade includes one or more broad recesses provided in one or more side surfaces of the blade, wherein at least one of the broad recesses is bounded at vertically opposite sides by the tapered portion and the spine and at longitudinally opposite sides by narrow supporting elements extending from the spine to the tapered portion. Embodiments of the cutting blade have a substantially reduced average wedge thickness which reduces cutting resistance to due to the wedging effect. Embodiments of the cutting blade provide a reduced total surface area of the one or more sides surfaces in contact with an item being cut by the blade which reduces cutting resistance due to friction between the side surfaces of the blade and the item. The present invention also provides for methods of forming a cutting blade, such as by near-net or additive manufacturing techniques.

### CROSS-REFERENCE TO RELATED APPLICATIONS

This Utility Patent Application is a U.S. National Stage filing under 35 U.S.C. § 371 of PCT/AU2015/000036, filed Jan. 22, 2015, which claims priority to U.S. Provisional Application No. 61/930,195, filed Jan. 22, 2014, incorporated by reference herein.

### TECHNICAL FIELD

The present invention relates to blades for cutting and particularly although not exclusively to knife blades such as kitchen knives.

### BACKGROUND OF INVENTION

Cutting blades such as kitchen knife blades, are typically formed by a process in which a knife blank is produced such as by forging or stamping a piece of metal into a shape that closely resembles the final form of the knife blade. The blank typically includes a knife blade comprising a spine and an opposite edge, which is subsequently sharpened to form a cutting edge, extending longitudinally from a bolster to a tip where, in the case of a chefs knife, the spine and the cutting edge meet. The blank typically includes a tang extending from the bolster in an opposite direction to the knife blade to which a plastic or wooden handle is attached by any suitable means such as with rivets or the like. Other knives include a handle that is formed of metal and is connected to the tang or to the bolster such as by a metal brazing, welding or other like process so as to produce a knife having the appearance of the blade and handle having been formed as a single integral component. As mentioned above, the edge of the blade opposite the spine is typically sharpened in a grinding process and the resulting blade, having a sharpened cutting edge, may be honed and polished to produce the final product.

Lower cost knife blades can include a narrow band of material along the cutting edge which is ground to produce a concave or “hollow grind” in which opposite sides of the ground cutting edge are formed with opposite concave ground bands (i.e. curved inwardly) that meet at the cutting edge. The concave ground cutting edge may be supplemented with a single or double bevel (i.e. V-shaped grind to form the cutting edge. Better quality kitchen knives typically have what is referred to as a “wedge grind” in which the blade has a continuous taper from the spine, which is the thickest part of the knife blade, to the cutting edge, which is the thinnest part of the knife blade. The “wedge grind”, sometimes also referred to as the full flat grind, may include a secondary grind such as a single bevel or double bevel grind at the cutting edge. Manufacturing processes by which knife blades are typically produced are referred to as subtractive manufacturing techniques as the knife blank is stamped from a sheet of metal and further material is removed from the knife blank, such as by grinding, to form the final knife blade.

The purpose of the cutting edge of a knife blade is to engage an item, such as a food item, and to cut through the food item while the spine provides strength for the knife blade and support for the cutting edge. The side surfaces of the knife blade which extend from the cutting edge to the spine, sometimes also referred to as “cheeks” of the knife blade, occupy an intermediate portion of the knife blade between the cutting edge and the spine. A thickness of the knife blade, defined by the distance between opposite side surfaces of the knife blade, typically tapers from the spine to the cutting edge. In the case of a wedge grind knife blade, the knife blade has a substantially constant taper from the spine to the cutting edge.

Knife blades can be employed in a chopping action in which the cutting edge of the blade is forced directly through a food item or in a slicing action in which the knife blade is also moved in a back and/or forth motion while cutting through the food item. Resistance is experienced by a user when cutting through a food item with a knife blade. Such resistance can be particularly problematic in circumstances where a knife blade is to be used for long periods such as by professional cooks, butchers, chefs and the like. It has been found that resistance experienced by a user during cutting of a food item is primarily due to three main factors. One such factor is cutting edge resistance, which results from the cutting edge of the blade stressing the food material beyond its yield and tensile strength to thereby shear the food item at the cellular fibre level thereby initiating cutting of the food item. Cutting edge resistance can occur whether the blade is forced in a linear downward direction through the food item (i.e. chopping) or in a linear downward direction as well as with a back and forth motion of the knife blade (i.e. slicing). Another factor is blade “wedging” resistance, which results from the wedge angle of the side surfaces of the knife blade pushing the food apart as the knife blade penetrates through the food item. The harder the food item being cut by the knife blade the greater the “wedging” resistance that will be experienced during cutting. The third factor is blade surface resistance, which results from friction between the side surfaces of the knife blade and the food item as the cutting edge penetrates through the food item. This form of resistance can be the largest contributor to cutting resistance particularly if the food item is wet and/or sticky and has a relatively high coefficient of friction. Wet and sticky foods will tend to form a seal against the side surface of the knife blade thus creating a vacuum therebetween. This vacuum increases the surface resistance over and above that which is attributable to friction between the blade surface and the food item alone. The greater the surface area of the food item and the side surfaces of the blade that are in contact with each other, the greater the resulting friction therebetween.

Accordingly, a desirable outcome of the present invention is to provide a cutting blade that ameliorates the problems associated with existing cutting blades such as cutting resistance and resultant user fatigue.

### SUMMARY OF INVENTION

Accordingly, in one aspect, the present invention provides a cutting blade comprising: a cutting edge, a spine and opposite side surfaces; a tapered portion of the blade immediately adjacent the cutting edge in which a thickness of the blade defined as a transverse distance between the opposite side surfaces tapers towards the cutting edge; one or more broad recesses provided in one or more side surfaces of the blade, wherein at least one of the broad recesses is bounded at vertically opposite sides by the tapered portion and the spine and at longitudinally opposite sides by narrow supporting elements extending from the spine to the tapered portion.

At least one of the recesses can have a base in which the thickness of the blade is, at least in part, substantially the same or thinner than a maximum thickness of the blade at an adjoining portion of the tapered portion and that, at least in part, is thinner than a thickness of the blade at an adjoining portion of the spine. Furthermore, at least one of the recesses can include a substantially planar base bounded by side surfaces upstanding from the base that adjoin the spine and the supporting elements, and in an embodiment also includes a side surface upstanding from the base that adjoins the tapered portion. In an embodiment, the base tapers substantially continuously with the adjoining portion of the tapered portion.

The sides of the recess preferably define a boundary of the recess along, at least in part, curved lines or substantially straight lines whereby, in the latter case, the boundary is substantially polygonal. Preferably, the boundary is defined, at least in part, along arcuate lines at which the substantially straight lines meet.

In embodiments of the cutting blade, both of the side surfaces of the blade include the broad recesses and the narrow supporting elements. Preferably, the broad recesses and the narrow supporting elements on one of the side surfaces are substantially symmetrical with the broad recesses and the narrow supporting elements on the other side surface. In yet a further preferred embodiment, the sides surfaces of the blade are substantially symmetrical with each other.

In embodiments, at least one of the recesses is shallowest immediately adjacent the tapered portion and is deepest immediately adjacent the spine. At least one of the recesses can become progressively deeper towards the spine. Preferably, the minimum thickness of the blade within any one of the recesses is up to 80% or 70% or 60% or 50% or 40% or 30% or 20% of the thickness of an adjoining portion of the spine. At least one of the broad recesses can have a vertical dimension that is greater than a vertical dimension of either an adjoining portion of the tapered portion or an adjoining portion of the spine. In embodiments, the broad recesses together occupy more than 10% or more than 20% or more than 30% or more than 40% or more than 50% or more than 60% or more than 70% or more than 80% of a total surface area of at least one of the side surfaces of the blade.

In embodiments of the cutting blade, at least one of the narrow supporting elements is an elongated rib. Preferably, at least one of the elongated ribs tapers from a wider portion adjacent the tapered portion of the blade to a narrower portion adjacent the spine of the blade. In another embodiment, at least one of the elongated ribs tapers from a wider portion adjacent the spine of the blade to a narrower portion adjacent the tapered portion of the blade. In further embodiments, the thickness of the blade at the narrow supporting elements becomes progressively thicker towards the spine of the blade. Preferably, at least one of the narrow supporting elements extends at an incline from the tapered zone to the spine. The incline is preferably between 45 and 90 degrees from the tapered zone to the spine and any increment therebetween.

In yet a further embodiment, the elongated supporting elements are in the form of a plurality of fingers extending from the spine towards the tapered portion immediately adjacent the cutting edge of the blade with the recesses defined in spaces between adjacent pairs of the elongated supporting elements.

In embodiments of the cutting blade, one of the side surfaces includes a plurality of channels extending from the tapered portion to the spine. At least one of the channels can have an open end at an edge of the blade adjoining the spine. In addition or in the alternative, the channels can meet a vent channel extending in a longitudinal direction of the knife blade.

The cutting blade, which is preferably a knife blade such as a kitchen knife (e.g. chefs knife, carving knife, boning knife, paring knife, cheese knife etc.) or a hunting or fishing knife, preferably includes a handle that is integrally formed with the cutting blade. Alternatively, the handle may be moulded over or fixed to a tang portion of the blade such as by rivets or the like.

In a preferred form, the handle includes a cavity comprising an opening for receiving one or more objects therewithin. Such objects may be other blade, sharpening or polishing or other accessories or the like. Preferably, the one or more objects includes one or more weights for adjusting a balance of the blade and the handle.

The tapered portion of the cutting blade preferably includes a pair of opposite concave surfaces meeting at the cutting edge. In embodiments, the cutting edge is an asymmetrical cutting edge. In further embodiments, the cutting edge is a single bevel cutting edge, however, the cutting edge may include a double bevel cutting edge.

In another aspect, the present invention provides a method of forming a cutting blade, the method including: forming a mould having an interior surface defining a mould cavity, wherein the interior surface is shaped to define an external surface of a cutting blade including a cutting edge, a spine and opposite side surfaces, a tapered portion of the blade extending longitudinally and immediately adjacent to the cutting edge in which a thickness of the blade defined as a transverse distance between the opposite side surfaces tapers towards the cutting edge and one or more broad recesses provided in one or more side surfaces of the blade, wherein at least one of the broad recesses is bounded at vertically opposite sides by the tapered portion and the spine and at longitudinally opposite sides by narrow supporting elements extending from the spine to the tapered portion; and placing metallic material in the mould cavity and applying pressure to form the metallic material into a cutting blade.

In an embodiment, the mould may be formed by a process including forming a temporary filler piece having an external surface shaped in the form of the external surface of the cutting blade, covering the filler piece with a ceramic material and causing the ceramic material to solidify to form the mould out of ceramic material, removing the filler piece from within the ceramic mould with heat to leave the internal mould cavity within a ceramic mould, and casting molten metal into shape of the internal mould cavity to form the knife blade.

In another embodiment, the method may include providing a die comprising die sections that when brought together form an interior mould cavity defined by an interior surface shaped in the form of the external surface of the cutting blade; injecting a mixture of particulate metallic material and a binder into the interior mould cavity under pressure to produce a form in the shape of a knife blade; separating the die sections and ejecting the form; and heating the form to remove the binder and to fuse the metallic material to form the knife blade.

In yet another embodiment, the method includes providing a die comprising die sections that when brought together form an interior mould cavity defined by an interior surface shaped in the form of the external surface of the cutting blade; and placing a metal blank between the die sections and bringing the dies sections together under pressure to form the metal blank into the shape of a knife blade.

In each of the aforementioned methods, the interior surface of the mould cavity is preferably shaped to complement the external shape of any one of the forms and embodiments of the knife blade disclosed above.

In another aspect, the present invention relates to a method of forming a cutting blade, the method including: producing a model of a cutting blade including a cutting edge, a spine and opposite side surfaces, a tapered portion of the blade immediately adjacent the cutting edge in which a thickness of the blade defined as a transverse distance between the opposite side surfaces tapers towards the cutting edge and one or more broad recesses provided in one or more side surfaces of the blade, wherein at least one of the broad recesses is bounded at vertically opposite sides by the tapered portion and the spine and at longitudinally opposite sides by narrow supporting elements extending from the spine to the tapered portion; generating geometric data corresponding to the shape and configuration of the cutting blade; providing a processor executing instructions stored on a computer readable non-transient storage medium produced from the geometric data for controlling a device for producing a three dimensional reproduction of the model represented by the geometric data using an additive process in which successive layers of metallic material are laid down thereby forming the cutting blade.

### BRIEF DESCRIPTION OF DRAWINGS

The present invention will now be described with reference to the accompanying drawings, which illustrate particular preferred embodiments of aspects of the present invention, wherein

FIG. 1 illustrates a perspective view of a knife blade in accordance with a preferred embodiment of the invention illustrating, in particular, broad recesses and interposed supporting elements in one side surface of the blade;

FIG. 2 illustrates a perspective view of the knife blade of FIG. 1 illustrating, in particular, channels formed into a side surface of the blade opposite the side surface comprising the recesses and supporting elements;

FIGS. 3, 4 and 5 illustrate side and top views of the knife blade of FIG. 1;

FIG. 6 illustrates a perspective view of a knife blade in accordance with another preferred embodiment of the invention illustrating, in particular, broad recesses and interposed supporting elements in one side surface of the blade and a handle formed with the blade, wherein the handle has a hollow internal cavity;

FIG. 7 illustrates a perspective view of the knife blade of FIG. 6 illustrating, in particular, channels formed into a side surface of the blade opposite the side surface comprising the recesses and supporting elements;

FIGS. 8, 9 and 10 illustrate side and top views of the knife blade of FIG. 6;

FIG. 11 illustrates a perspective view of a knife blade in accordance with a preferred embodiment of the invention illustrating, in particular, broad recesses and interposed supporting elements in one side surface of the blade;

FIG. 12 illustrates a perspective view of a knife blade in accordance with another embodiment illustrating, in particular, broad recesses formed into both side surfaces of the blade and, for each broad recess, a corresponding protrusion formed on the other side surface of the blade;

FIG. 13 illustrates a perspective view of the knife blade of FIG. 12 after a subsequent step of grinding the sides surfaces is carried out to remove the protrusions;

FIGS. 14 and 15 respectively illustrate a top view of the blade of FIG. 12 before and after removal of the protrusions;

FIGS. 16, 17 and 18 illustrate side, top reverse side views of the the knife blade of FIG. 11 illustrating the broad recesses and supporting elements in both side surfaces of the blade;

FIGS. 19, 20 and 21 illustrate a perspective, top and side views of a rotary cutting blade in accordance with another aspect of the invention comprising a cutting edge and opposite side surfaces extending towards a central zone wherein the side surfaces comprise broad recesses interposed by supporting elements;

FIGS. 22 and 23 illustrate a transverse cross section of a tapered portion of the blade of FIGS. 1 to 10 in more detail.

FIGS. 24 to 26 illustrate an embodiment of the method of forming the cutting blade including a mould or die formed of a plurality of mould or die sections that are brought together to form a mould cavity which is employed in a metal injection moulding process to form the knife blade of FIGS. 6 to 10;

FIGS. 27 to 30 illustrate an embodiment of the method of forming the cutting blade including a mould or die formed of a plurality of mould or die sections that are brought together to form a mould cavity in a metal pressing or stamping process to form the knife blades of FIGS. 11 to 18;

FIGS. 30 and 31 illustrate perspective views of a knife blade in accordance with another preferred embodiment of the invention illustrating, in particular, broad recesses and interposed narrow supporting elements in both side surfaces of the blade, wherein the supporting elements resemble fingers extending from the spine towards the cutting edge of the blade and wherein a thickness between side surfaces of the blade tapers continuously from a tapered portion of the blade immediately adjacent the cutting edge and through a base of the recess to the spine.

### DETAILED DESCRIPTION

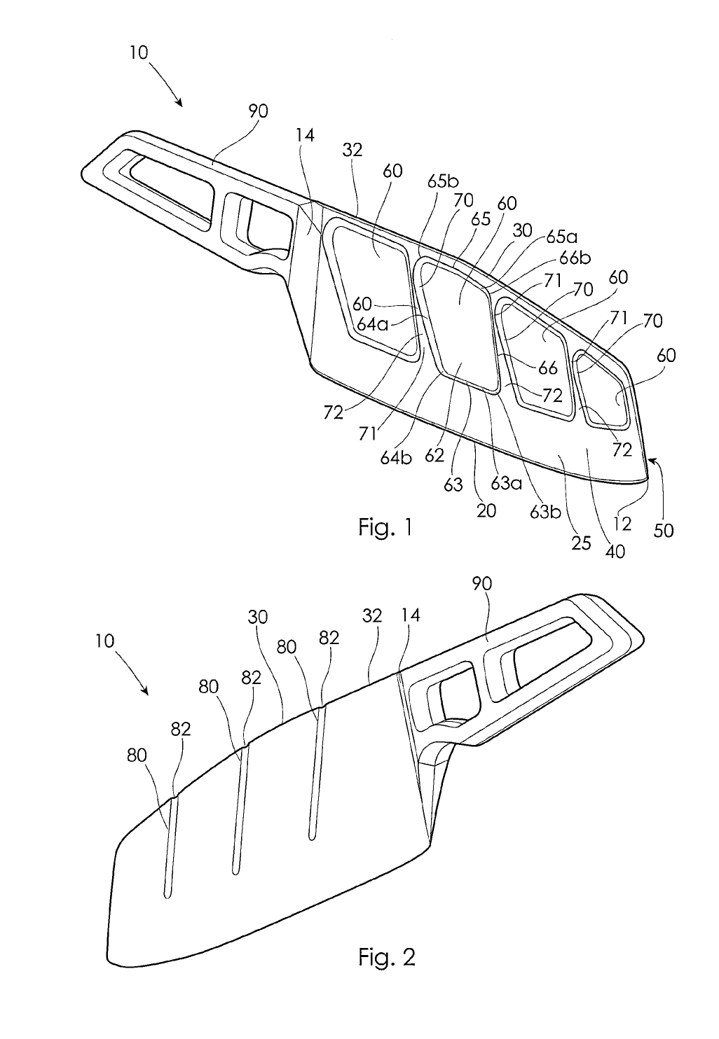

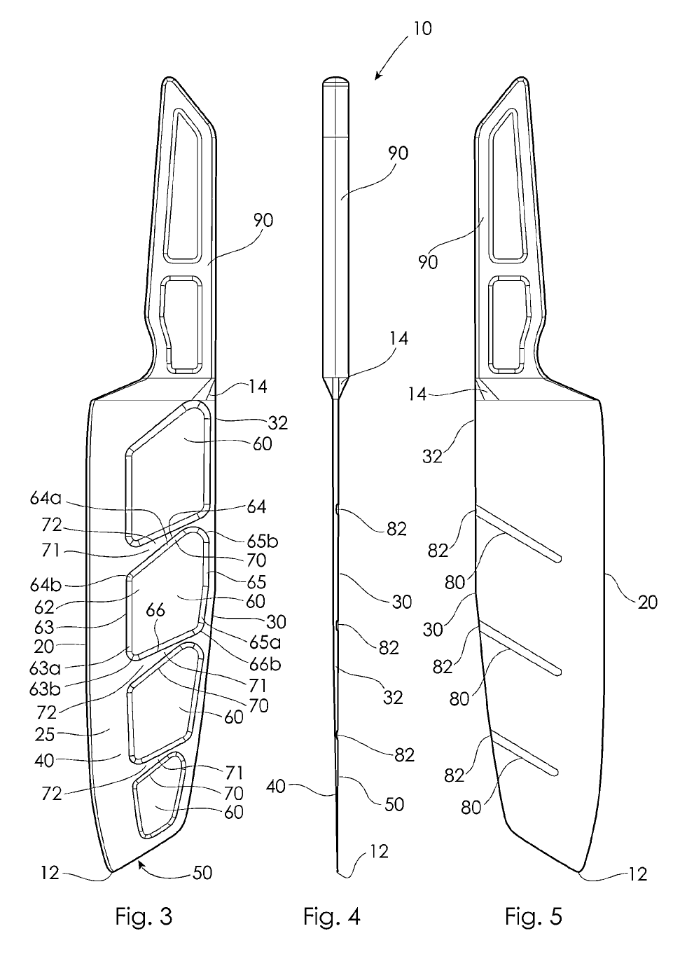

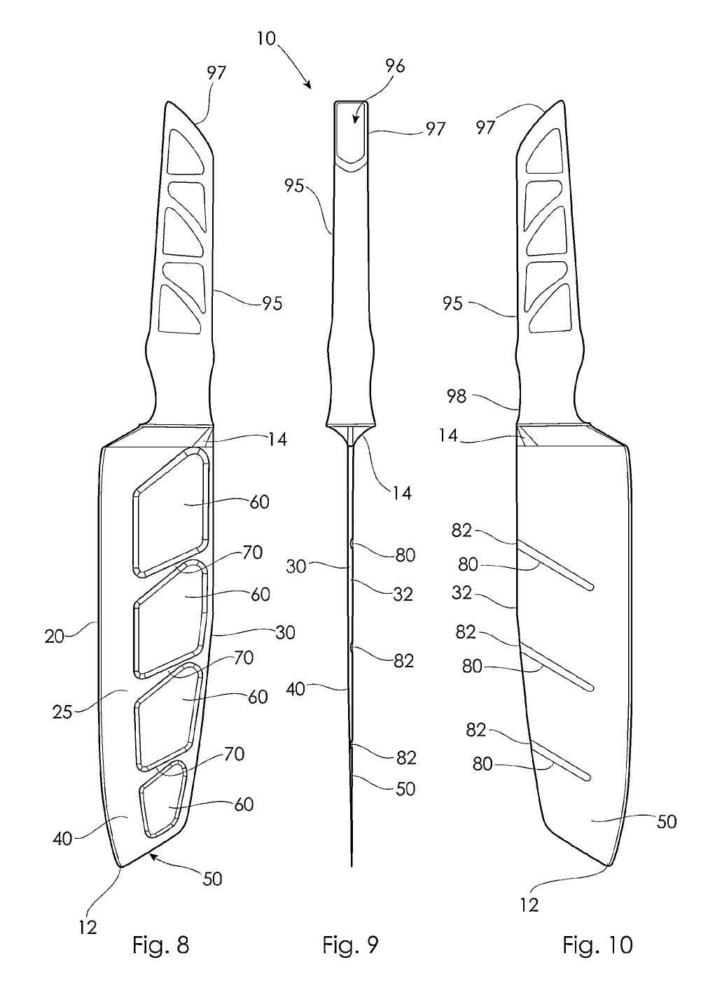

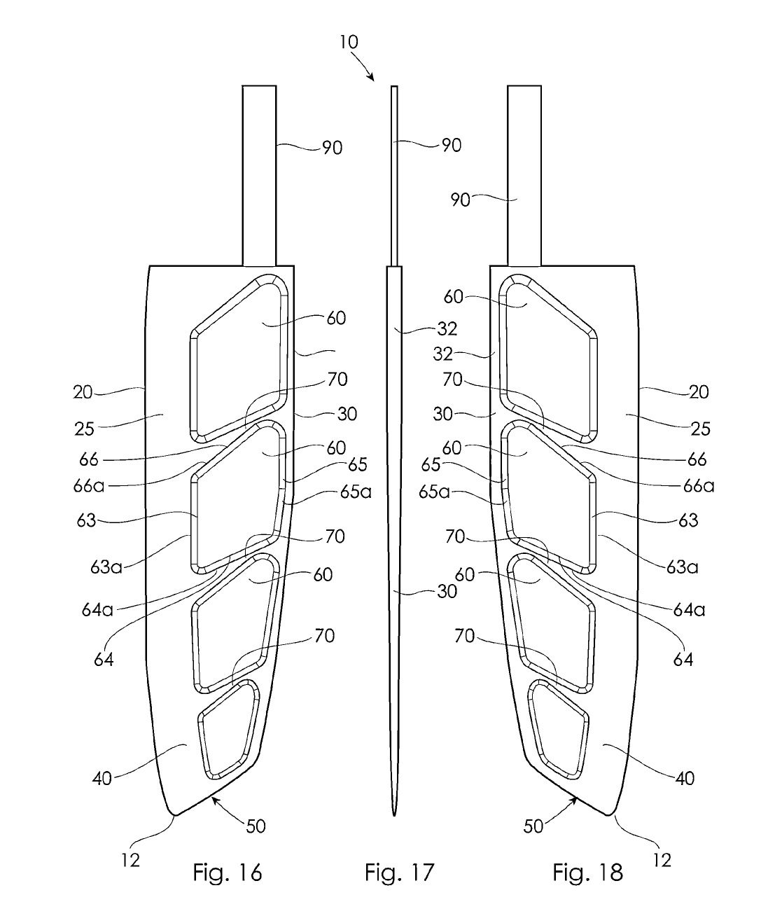

The present invention generally relates to a cutting blade. Embodiments of the invention are illustrated in FIGS. 1 to 18, 30 and 31 wherein like reference numerals are employed to identify like features. The embodiments of FIGS. 1 to 18, 30 and 31 are in the form of chefs knife blades 10. The knife blade 10 comprises a cutting edge 20, a spine 30 and opposite side surfaces 40, 50. The knife blade 10 includes a tapered portion 25 extending longitudinally and immediately adjacent the cutting edge 20 in which the thickness of the blade 10, defined as a transverse distance between the opposite side surfaces 40, 50, tapers towards the cutting edge 20. One or more broad recesses 60 are provided in one or more side surfaces 40, 50 of the blade 10, wherein at least one of the broad recesses 60 is bounded at vertically opposite sides 63, 65 by the tapered portion 25 and the spine 30 and at longitudinally opposite sides 64, 66 by narrow supporting elements 70 extending from the spine 30 to the tapered portion 25.

The terms “broad” and “narrow” as used herein, refer to relative dimensions of the recesses 60 and the supporting elements 70, preferably in a longitudinal direction of the knife blade 10. The broadness (i.e. the length or width dimension) of the broad recesses 60 in the longitudinal direction of the knife blade 10 is such as to preferably occupy a major proportion of the length of the blade 10 whilst the width dimension of the supporting elements 70 also in the longitudinal direction occupy a minor, and preferably as small as possible, proportion of the length of the blade 10. As will become apparent from the disclosure contained in this specification, the broadness of the recesses 60 and the narrowness of the interposing supporting elements 70 results in the blade 10 exhibiting reduced cutting resistance. This is due, at least in part, to the blade 10 having a substantially reduced average wedge thickness which reduces cutting resistance to due to the wedging effect and by reducing the total surface area of the one or more sides surfaces 40, 50 in contact with the food item which reduces cutting resistance due to friction between the side surfaces 40, 50 of the blade 10 and the food item particularly in comparison to a comparable sized wedge shaped knife blade with planar side surfaces. It is to be appreciated that the present invention may be applied to other forms of kitchen knives such as carving, paring, boning, cheese knives to name but a few. The invention may be applied to other knives not for use in the kitchen such as hunting and fishing knives.

Referring to the embodiments of FIGS. 1 to 18, 30 and 31, the knife blade 10 further includes a tip 12 at which the cutting edge 20 and the spine 30 meet and a bolster 14 at an opposite end of the knife blade 10. The cutting edge 20 of the knife blade 10 is operable for engaging and cutting though a food item and the spine 30 provides strength and support for the blade 10 and for the cutting edge 20. An intermediate portion 15 between the cutting edge 20 and the spine 30 transmits forces from the cutting edge 20 and the tapered portion 25 immediately adjacent the cutting edge to the spine 30. However, unlike existing wedge shaped knives with planar side surfaces, the broad recesses 60, which are provided in at least one of the side surfaces 40, 50 of the cutting blade 10, results in the blade 10 having a relatively shallow thickness (i.e. reduced volume) throughout a relatively large and preferably a major proportion of the intermediate portion 15 of the blade 10 between the tapered portion 25 immediately adjacent the cutting edge 20 and the spine 30. The relatively shallow thickness of the blade 10 between the tapered portion 25 and the spine 30 results in a substantially reduced average wedge thickness of the knife blade 10 which reduces cutting resistance due to the wedging effect.

In the embodiments of FIGS. 1 to 18, at least one of the recesses 60 has a base 62 that is preferably substantially planar and is bounded by respective side surfaces 63a, 65a, 64a, 66a upstanding from the base 62. The side surfaces 63a, 65a, 64a, 66a adjoin the tapered portion 25, the spine 30 and a pair of the supporting elements 70 of the blade 10 along the sides 63, 65, 64, 66 of the recess 60. In particular, a vertically opposite pair of the side surfaces 63a, 65a respectively adjoin the tapered portion 25 and the spine 30 of the blade 10 along the sides 63, 65. One or both of a longitudinally opposite pair of the side surfaces 64a, 66a adjoin a pair of the supporting elements 70 along the sides 64, 66, wherein the pair of supporting elements 70 are spaced apart from each other in the longitudinal direction of the blade 10. The sides 63, 65, 64, 66 and the side surfaces 63a, 65a, 64a, 66a of at least one, and preferably all of the recesses 60, are defined, at least in part, along substantially straight lines whereby a boundary 61 of the recess 60 is substantially polygonal. Furthermore, the boundary 61 is defined, at least in part, along arcuate lines 63b, 65b, 64b, 66b, preferably where arcuate side wall portions adjoin the substantially straight side surfaces 63a, 65a, 64a, 66a. Thus, the surface area of the side surfaces 40, 50 occupied by the recesses 60 is maximised and the surface area occupied by the supporting elements 70 is minimised.

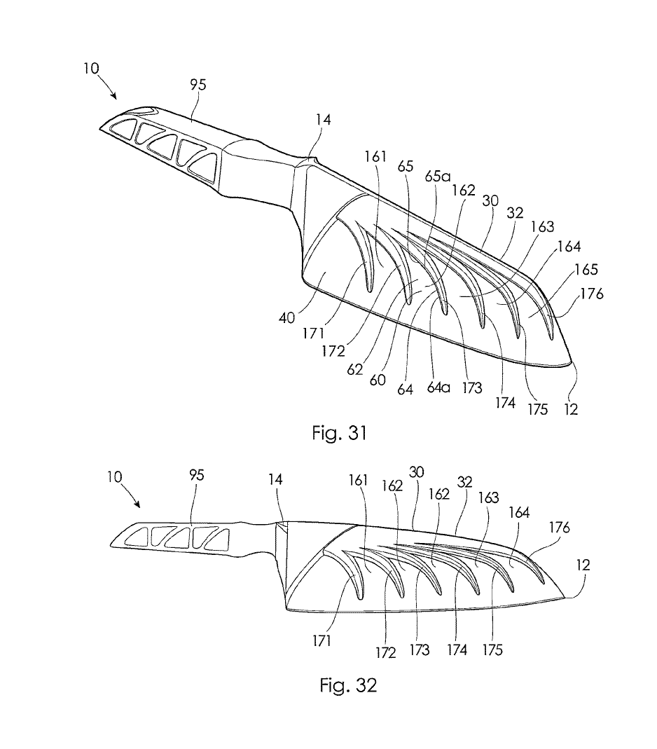

In the embodiments of FIGS. 31 and 32, at least one of the recesses 60 has a base 62 that is preferably substantially planar and is bounded by the tapered portion and the spine 30 at the vertically opposite sides 63, 65 of the recess 60 and by a pair of the narrow supporting elements 70 at the longitudinally opposite sides 64, 66 of the recess 60. The recess 60 includes side surfaces 65a, 64a, 66a upstanding from the base 62 that adjoin the spine 30 and the pair of the supporting elements 70. Thus, a longitudinally opposite pair of the side surfaces 64a, 66a adjoin a pair of the supporting elements 70 along the longitudinally opposite sides 64, 66 wherein the pair of supporting elements 70 are spaced apart from each other in the longitudinal direction of the blade 10. However, in contrast to the embodiments of FIGS. 1 to 18, in the blade 10 embodiment of FIGS. 30 and 31, the base 62 of the recess 60 seamlessly adjoins the tapered portion 25 of the blade 10 along the remaining lower side 63 of the recess 60. Thus, in this embodiment, the base 62 tapers substantially continuously with the adjoining portion of the tapered portion 25. The sides 65, 64, 66 and the side surfaces 65a, 64a, 66a of at least one, and preferably all of the recesses 60, are defined, at least in part, along substantially curved lines. One of the longitudinally opposite side surfaces 64a along one of the sides 64 seamlessly merges into the side surface 65a at along the side 65 adjoining the spine 30 in a continuous curve.

In the embodiments of FIGS. 1 to 18, 30 and 31 the narrow supporting elements 70 provide support for the tapered portion 25 and the cutting edge 20 by transmitting forces from the cutting edge 20 to the spine 30. The supporting elements 70 and in particular an outwardly facing surface 71 thereof, which is spaced apart from the base 62 of an adjacent recess 60, contacts a food item being cut as the cutting edge 20 penetrates through the food item and maintains the food item out of contact with at least part of the base 62 of the broad recess 60. As the supporting elements 70, and the outwardly facing surface 71 thereof, are narrow a total surface area of the one of more of the side surfaces 40, 50 comprising the broad recesses 60 and the supporting elements 70 that is in contact with the food item being cut is relatively small. Thus, cutting resistance due to friction between the side surfaces 40, 50 of the blade 10 and the food item is reduced as the total surface area of the one or more sides surfaces 40, 50 comprising the recesses 60 in contact with the food item is less than that of a comparable wedge shaped knife blade with planar side surfaces. Furthermore, the recesses 60 reduce the propensity for a vacuum to be established between the one or more sides surfaces 40, 50 comprising the recesses 60 in contact with the food item is less than that of a comparable wedge shaped knife blade with planar side surfaces.

At least one of the narrow supporting elements 70 and as illustrated in the embodiments of FIGS. 1 to 18, 30 and 31 preferably all of the supporting elements 70 are in the form of elongated ribs 72. At least one, preferably all, of the elongated ribs 72 taper from a wider portion 74 adjacent the tapered portion 25 of the blade 10 to a narrower portion 76 adjacent the spine 30 of the blade 10. Within the narrow supporting elements 70, the blade 10 is thinnest at the wider portion 74 adjacent the tapered portion 25 and becomes progressively thicker towards the narrower portion 76 adjacent the spine 30 of the blade 10. Furthermore, at least one and preferably all of the narrow supporting elements 70 extend at an incline from the tapered zone 25 to the spine 30. The angle of incline of the supporting elements 70 is preferably optimised for the purpose for which the knife blade 10 is designed, for example a chefs knife which is typically employed for downward and forward cutting motions may have supporting elements 70 that extend at an angle downwardly and forwardly from the spine 30. In contrast, a form of the knife blade 10 used for slicing sashimi or for carving which may typically be used to cut food items in a pulling motion may have supporting elements 70 that extend at an angle downwardly and rearwardly from the spine 30. The angle of incline of the supporting elements 70 is preferably between 45 and 90 degrees from the tapered zone 25 to the spine 30. In the embodiment of FIGS. 31 and 32, the narrow supporting elements 70 form a plurality of fingers 171, 172, 173, 174, 175, 176 extending from the spine 30 towards the tapered portion 25 immediately adjacent the cutting edge 20 of the blade 10 with recesses 161, 162, 163, 164, 165 defined in spaces between adjacent pairs of the fingers 171, 172, 173, 174, 175, 176. In each of the embodiments of FIGS. 1 to 18, 30 and 31, the external surface 71 of each of the narrow supporting elements 70 is convex in transverse cross section. In each embodiment the external surface 71 can be outwardly curved in transverse cross section as represented in the embodiment of FIGS. 30 and 31.

It is to be appreciated that the shape and configuration of the blade 10, the spine 30, the recesses 60 and the intervening supporting elements 70 can be optimised, such as by finite element analysis or any computer aided design technique, so as to maximise the surface area of the side surfaces 40, 50 occupied by the recesses 60 and to minimise the surface area occupied by the supporting elements 70 (i.e. the surface area of the outward facing surfaces 71) whilst providing sufficient strength (e.g. rigidity) to the blade 10 and support to the cutting edge 20 and the adjacent tapered portion 25 of the blade 25. Furthermore, this optimisation process can be carried out separately for each knife blade type (e.g. chefs knife, carving knife, paring knife, boning knife, cheese knife, hunting or fishing knife etc.). Thus, each different form of the knife blade 10, depending on the duties to be carried out by the knife blade 10 and the characteristics of the materials used to form the knife blade 10, can have a different configuration particularly with respect to the dimensions, quantity, shapes and configurations of the broad recesses 60 and the supporting elements 70.

Referring to the embodiments illustrated in FIGS. 1 to 18, the thickness of the blade 10 within the base 62 of any one of the recesses 60 is the same or thinner than a maximum thickness of the blade 10 at an adjoining portion of the tapered portion 25. In the case of the embodiment of FIGS. 30 and 31, the thickness of the blade 10 within the base 62 of any one of the recesses 60 is, at least in part, substantially the same than a maximum thickness of the blade 10 at an adjoining portion of the tapered portion 25 and becomes progressively thicker towards the spine 30. Nevertheless, in each embodiment the thickness of the blade 10 within the base 62 of any one of the recesses 60, at least in part and preferably in whole, is thinner than a thickness of the blade 10 at an adjoining portion of the spine 30. In the embodiments illustrated in the Figures, the base 62 of each one of the recesses 60 is shallowest immediately adjacent the tapered portion 25 and is deepest immediately adjacent the spine 30. Furthermore, the base 62 of each one of the recesses 60 becomes progressively deeper towards the spine 30. Preferably, the minimum thickness of the blade within any one of the recesses 60 is up to 80% or 70% or 60% or 50% or 40% or 30% or 20% of the thickness of an adjoining portion of the spine 30.

In the embodiments of FIGS. 1 to 18, 30 and 31, the broad recesses 60 each have a vertical dimension, which is a dimension that is at substantially 90 degrees to a longitudinal direction of the knife blade 10, that is greater than a vertical dimension of either an adjoining portion of the tapered portion 25 or an adjoining portion of the spine 30. In these and other non-illustrated embodiments, the broad recesses 60 together occupy more than 10% or more than 20% or more than 30% or more than 40% or more than 50% or more than 60% or more than 70% or more than 80% of a total surface area of at least one of the side surfaces 40, 50 of the blade 10 or any increment therebetween.

As can be seen in the embodiments illustrated in FIGS. 2, 4, 5, 7, 9 and 10, one of the side surfaces 40, 50 includes a plurality of channels 80 extending from the tapered portion 25 to the spine 30. At least one of the channels 80 has an open end 82 at an edge 32 of the blade 10 adjoining the spine 30. In another embodiment, the channels 80 meet at a vent channel (not shown) extending in a longitudinal direction of the knife blade 10. The vent channel includes an open end located towards the bolster 14 of the blade 10. The open ends 82 of the channels 80 of the former embodiment and the open end of the vent channel of the latter embodiment allow for the ingress and egress of air to the channels 80 and the vent channel to reduce propensity for a vacuum to form between the food item and the side surface 40, 50 of the blade comprising the channels 80, thereby reducing resistance experienced during cutting of food items with the blade 10.

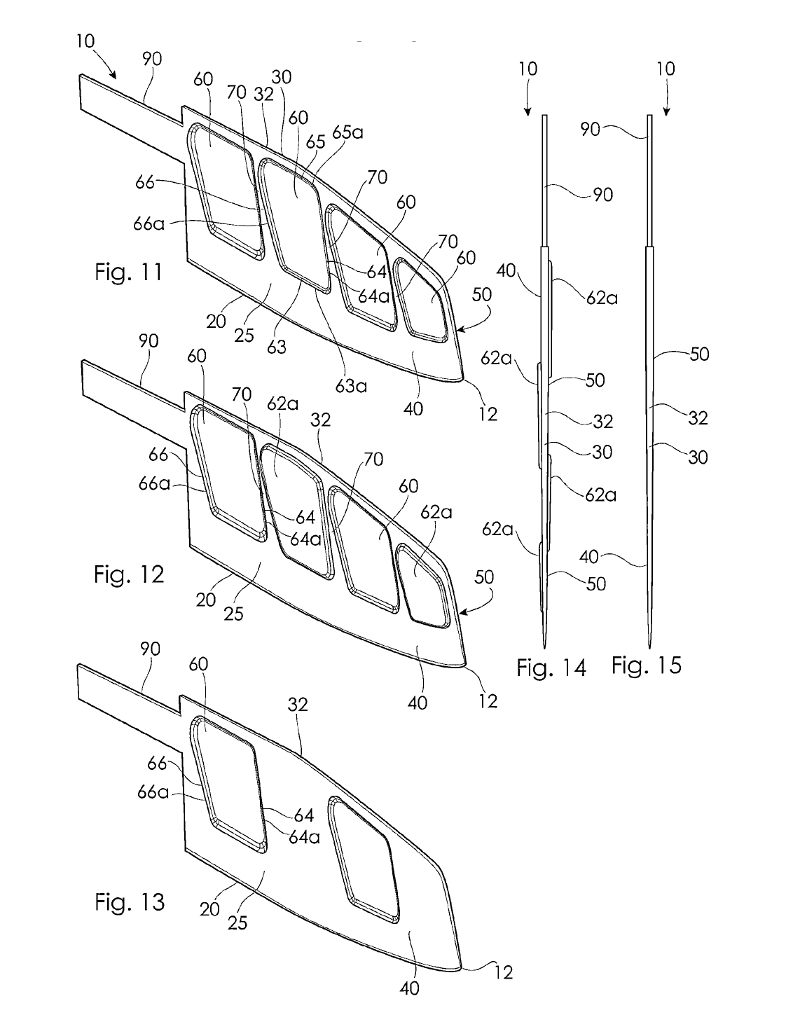

In the embodiment of the knife blade 10 of FIGS. 11 to 18, the broad recesses 60 are provided in both sides 40, 50 of the blade 10 and are separated from each other or interposed by the narrow supporting elements 70. Although not illustrated in FIGS. 11 to 18, a vent channel may be provided within each of the narrow supporting elements. In FIGS. 11, 16, 17 and 18, the broad recesses 60 and the narrow supporting elements 70 on one of the side surfaces 40 are substantially symmetrical with the broad recesses 60 and the narrow supporting elements 70 on the other side surface 50. Furthermore, the side surfaces 40, 50 of the blade 10 are substantially symmetrical with each other. In FIGS. 13 and 15, the broad recesses 60 alternate along the blade 10 between the side surfaces 40, 50. During production of the blade 10 embodiment of FIGS. 12 to 15, such as by a metal pressing/stamping process described below, a broad recess 60 is formed on one of the sides surfaces 40, 50 with a complementary shaped protrusion 70a formed on the other side surface 40, 50. The protrusions 70a on one or both of the side surfaces 40, 50 are removed by grinding to finish the knife blade 10. The narrow supporting elements 70 are formed between adjacent pairs of the broad recesses 60 which are on opposite sides 40, 50 of the blade 10. The embodiments of FIGS. 11 to 18 are advantageous in that the provision of broad recesses 60 on both sides surfaces 40, 50 of the blade 10, and in some embodiments such as in FIGS. 11 and 16 to 18, with supporting elements 70 with narrow outwardly facing surfaces 71, means that the blade 10 can be used by a left or right handed user and still provide the same advantageous benefits of reducing cutting resistance due to the reduction of wedging resistance and blade surface resistance.

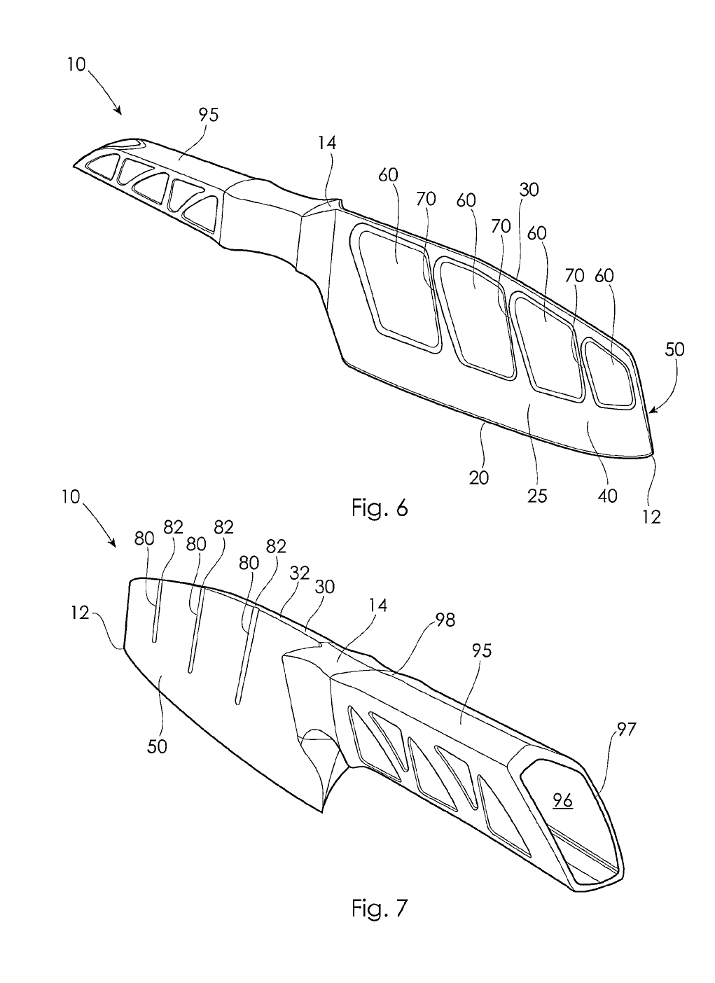

FIGS. 1 to 5 and 11 to 18 illustrate a knife blade 10 comprising a tang 90 over which a handle made of metal, wood, plastic or the like may be formed. The embodiments of the knife blade 10 illustrated in FIGS. 6 to 10, 30 and 31 include a handle 95 integrally formed with the knife blade 10. Referring to the knife blade 10 of FIGS. 6 to 10, 30 and 31, the handle 95 is formed integrally with the knife blade 10 and includes a cavity 96 that extends longitudinally through the handle 95 from an open end 97 to a closed end 98. The open end 97 may be selectively closable such as by a stopper, cap or the like (not shown) which may be held in place within the cavity 96 at the open end 97 by an interference fit, or by a threaded coupling or any other suitable means. The cavity 96 is operable for receiving and containing one or more objects therewithin such as smaller knife blades, sharpening and/or honing and/or polishing devices. The cavity 96 may also be operable for receiving and containing one or more weights at any one or more locations along the length of the handle for altering and customising the balance of the combination knife blade 10 and handle 95. The weights may be removable or once installed may be fixed and not intended for removal.

FIGS. 22 and 23 illustrate a transverse cross section of the tapered portion 25 of the blade 10 in more detail. The opposite side surfaces 40, 50 of the knife blade 10 at the tapered portion 25 converge towards each other to provide a tapering transverse thickness of the blade 10 towards the cutting edge 20. In the embodiment illustrated in FIGS. 22 and 23, a cutting edge zone 26 of the tapered portion 25 immediately adjacent the cutting edge 20 is comprised of opposite concave surfaces 44, 54 which taper towards the cutting edge 20 in a manner in which the thickness of the blade 10 gradually decreases towards the cutting edge 20. At the cutting edge 20 the blade 10 includes a single bevel 22, which is preferably provided by a grinding process as part of a post finishing step in the production of the knife blade 10. Thus, in the embodiment illustrated in FIGS. 22 and 23, the concave surfaces 44, 54 are asymmetrical and with the provision of a single bevel 22 cutting edge 20, results in the blade having a minimal thickness immediately adjacent the cutting edge 20 to thereby minimise resistance to cutting associated with the wedge thickness of the blade 10 in the region of the cutting edge 10. Furthermore, the sides surfaces 40, 50 of the blade 10 approaching the cutting edge 20 are substantially parallel and close together to define a relatively thin portion of the blade 10. Thus, as the blade 10 is worn away after numerous instances of sharpening the bevel 22 does not become substantially thicker than its original thickness thus extending the useable life of the blade 10. In another embodiment (not shown), the cutting edge 20 of the blade 10 may be formed with a double bevel (i.e. a V-shaped cutting edge).

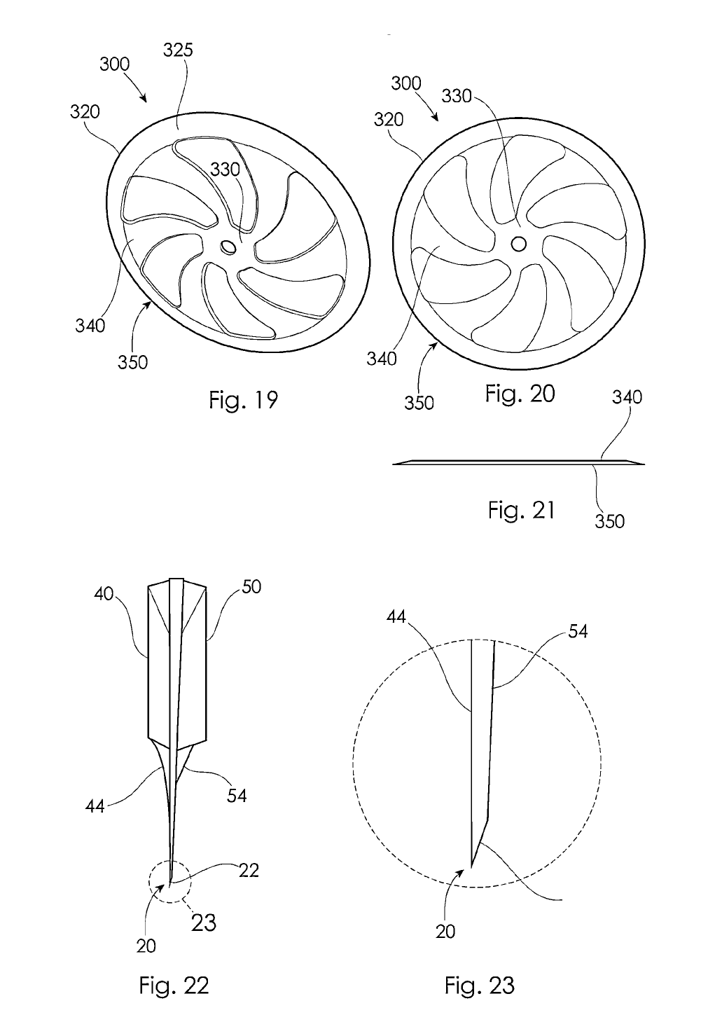

FIGS. 19 to 21 illustrate another aspect of the invention in the form of a rotary cutting blade 300. The rotary cutting blade 300 includes a circular cutting edge 320 and opposite disc shaped side surfaces 340, 350, a tapered portion 325 of the blade immediately adjacent the cutting edge 320 in which a thickness of the blade defined as a transverse distance between the opposite side surfaces 340, 350 tapers towards the cutting edge 320. The rotary cutting blade 300 includes one or more broad recesses 360 provided in at least one and preferably both side surfaces 340, 350 of the blade 300. The broad recesses 360 are bounded at opposite sides 363, 365 by the tapered portion 325 and by a central hub 330 and at transversely opposite sides 364, 366 by narrow supporting elements extending from the hub 330 to the tapered portion 325. The broad recesses 360 separated by narrow supporting elements 370 provide the rotary cutting blade 300 with similar advantages in terms of reducing cutting resistance to those exhibited by embodiments of the knife blade 10 described above.

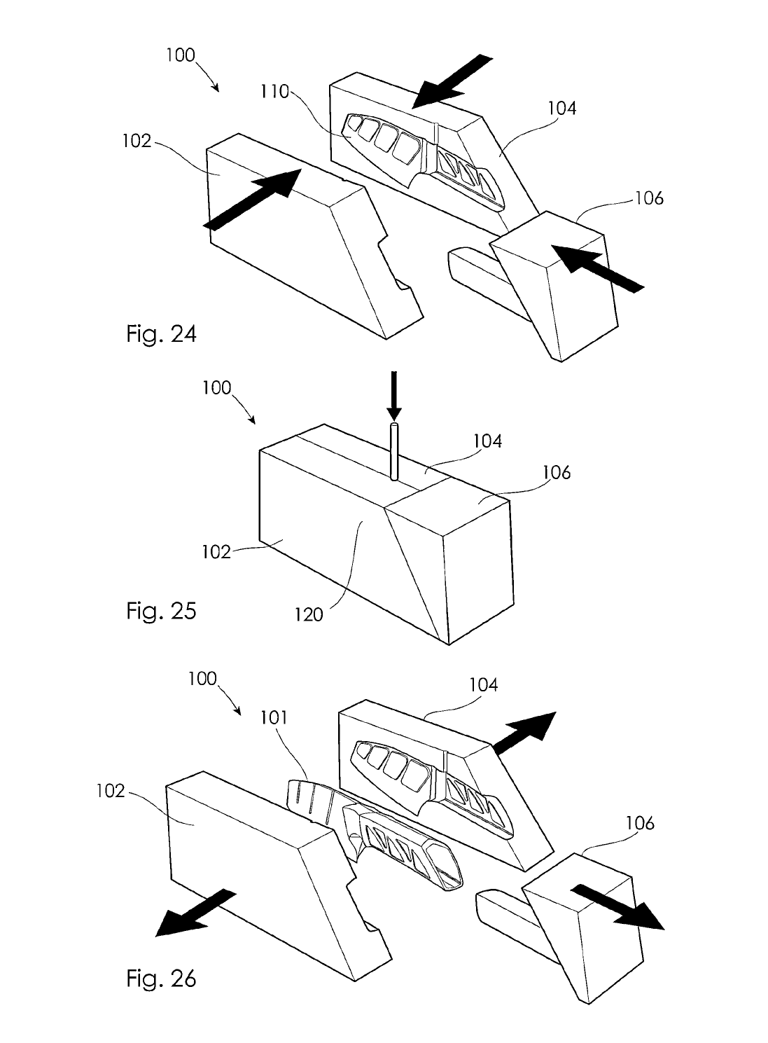

In another aspect, the present invention involves a method or methods of forming a cutting blade, in particular a knife blade. Some methods comprise near-net manufacturing methods, such as additive manufacturing methods. However, some methods used to form certain knife blade embodiments include subtractive manufacturing techniques. In a broad sense, and with reference to the embodiments of FIGS. 24 to 30, the method can include a step of forming a mould or die 100, 200 having an interior surface 110, 210 defining a mould cavity 120, 220, wherein the interior surface 110, 210 is shaped to define an external surface of a cutting blade 10 in accordance with any of the embodiments described above and illustrated in the Figures. Thus, the interior surface 110, 210 of the mould 100, 200 is shaped to form the cutting blade 10 including the cutting edge 20, the spine 30, the opposite side surfaces 40, 50 and the tapered portion 25 of the blade 10 immediately adjacent the cutting edge 20 in which the thickness of the blade 10 defined as a transverse distance between the opposite side surfaces 40, 50 tapers towards the cutting edge 20. Furthermore, the interior surface 110, 210 of the mould 100, 200 is shaped to form the cutting blade 10 with one or more of the broad recesses 60 provided in one or more of the side surfaces 40, 50 of the blade 10, wherein at least one of the broad recesses 60 is bounded at vertically opposite edges by the tapered portion 25 and the spine 30 and at longitudinally opposite side edges by the narrow supporting elements 70 extending from the spine 30 to the tapered portion 25. The method also includes a step of placing metallic material in the mould cavity 120, 220 and applying pressure to form the metallic material into a cutting blade 10, 201. Embodiments of the method include additive or near net manufacturing methods, described below, that enable knife blades with relatively complex forms to be produced such as the blade embodiments of FIGS. 1 to 10, 30 and 31. Other embodiments of the method include more traditional subtractive manufacturing methods such as metal pressing and grinding to produce the knife blade embodiments of FIGS. 11 to 18.

FIGS. 24 to 26 illustrate an embodiment of the method in the form of a metal injection moulding (MIM) method in which metal injection moulding feedstock is produced from a mixture of fine metal powder (i.e. particulate) and one or more binders such as parrifin and a secondary thermoplastic polymer. A metal injection moulding machine includes the mould 100 which is comprised of mould or die sections 102, 104, 106 as illustrated in FIG. 24. The mould sections 102, 104, 106 are brought together by the machine as illustrated in FIG. 25 to form the mould cavity 120. The mixture is fed into the mould cavity under heat and pressure to form a part 101, which is referred to as “green”, which is then ejected from the cavity 120 as illustrated in FIG. 26. The “green” parts 101 are submerged into a solvent to remove the primary binder. After removal of the primary binder the parts 101 are referred to as “brown” parts. The brown parts are then placed in a kiln or furnace to remove the remaining binder. Once the binder is removed, the particles of the metal fuse together and the component transforms to its final state, thus enabling knife blade with relatively complex forms to be produced such as the blade embodiments of FIGS. 1 to 10, 30 and 31.

Another near net manufacturing process, not illustrated in the Figures, includes investment casting. Investment casting involves producing a wax or plastic pattern substantially corresponding to the shape of the cutting blade 10 such as by a moulding process or the like. The wax patterns are then attached to a sprue. The sprue with attached wax patterns, undergoes the investment process in which a ceramic mould, known as the investment, is produced by repeating steps of coating stuccoing and hardening. The first step involves dipping the cluster into a slurry of fine refractory material and removing any excess so a uniform surface is produced. The fine material is used first to give a smooth surface finish and reproduce fine details. In the second step, the cluster is stuccoed with a course ceramic particle, by dipping it into a fluidised bed and placing it in a rainfall sander or applying it by hand. Finally the coating is allowed to harden. These steps are repeated until the investment is the required thickness, usually 5 to 15 mm thick. The investment is allowed to completely dry and is then placed in a furnace to melt out or vaporise the wax. The mould may be subjected to an additional heating process to remove any moisture and residual wax and sinter the mould. Metal may then be gravity poured or vacuum or tilt cast or the like into the moulds via the sprue. The final step is referred to as divesting in which the mould shell is removed to release the casting to reveal the cast cutting blades 10. The aforementioned investment casting method enables knife blades with relatively complex forms to be produced such as the blade embodiments of FIGS. 1 to 10, 30 and 31.

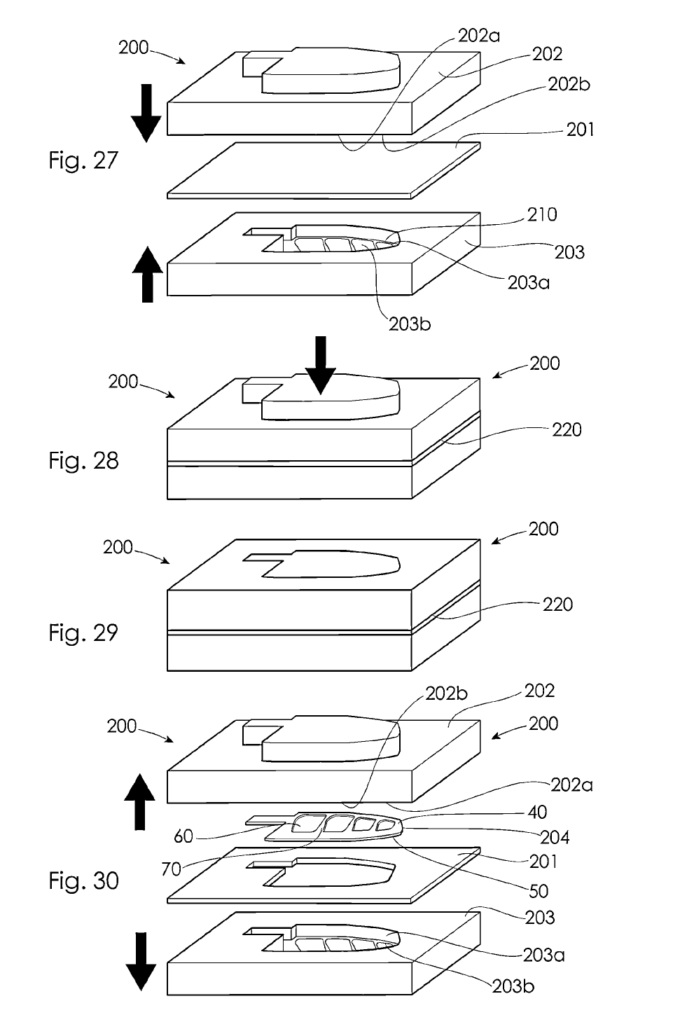

FIGS. 27 to 30 illustrate an embodiment of the method comprising a metal press apparatus including a mould or die 200 which is comprised of mould or die sections 202, 204 as illustrated in FIGS. 27 to 30. The mould/die sections 202, 204 are brought together in a hydraulic, mechanical or pneumatic press machine as illustrated in FIG. 28 to form the mould cavity 220. Prior to bringing together the mould/die section 202, 204, a metal blank 201 is placed between the mould sections 202, 204 which are brought together to stamp/compress the blank 201 into the shape of the cutting blade 204 illustrated in FIG. 30. The mould/die sections 202, 203 each have a respective interior surface 202a, 203a, that when brought together define the mould cavity 220. The interior surface 202a, 203b of each mould/die section 202, 203 is shaped to define the external surface of the cutting blade 10 in accordance with any of the embodiments described above and illustrated in the Figures. Thus, the interior surface 202a, 203a of each of the mould/die sections 202, 203 is shaped to form the cutting blade 10 including the cutting edge 20, the spine 30, the opposite side surfaces 40, 50 and the tapered portion 25 of the blade 10 immediately adjacent the cutting edge 20. Furthermore, the interior surface 202a, 203a of each of the mould sections 202, 203 is shaped to form the cutting blade 10 with the broad recesses 60 and the interposing narrow supporting elements 70 in one or both side surfaces 40, 50 of the blade 10 as in the embodiment illustrated in FIGS. 11 and 16 to 18. FIGS. 27 and 30 illustrate the interior surface 203a of a lower one of the mould sections 203 including surface features 203b that are shaped complementarily to the shape of one of the side surfaces 40, 50 of the knife blade 10 including, in particular, the broad recesses 60 and narrow supporting elements 70. Similarly, the interior surface 202a of the upper one of the mould sections 202 includes similar surface features (not shown) that are shaped complementarily to the shape of the other one of the side surfaces 40, 50 of the knife blade 10 including, in particular, the broad recesses 60 and narrow supporting elements 70. In the method of FIGS. 25 to 28, the metal blank 201 is pressed by the mould sections 202, 203 into the final form of the knife blade 10, such as the embodiment illustrated in FIGS. 11 and 16 to 18, with the broad recesses 60 and narrow supporting elements 70 in both side surfaces 40, 50 of the blade 10. The resulting knife blade 10 is formed with the tang 90 to which the handle 95, which may or may not be a hollow handle capable of receiving objects such as weights, may be fixed in a subsequent step. Furthermore, the cutting edge 20 is sharpened in a final finishing step to include a single bevel or double bevel cutting edge.

In an alternative form of the method of FIGS. 27 to 30 the interior surface 202a of only one of the mould sections 202 is shaped to define the external surface of the cutting blade 10 with the broad recesses 60 and narrow supporting elements 70. The interior surface 203a of the other one of the mould sections 203 is shaped, such as with appropriately shaped recesses and, possibly protrusions, (not shown) that are shaped to allow the first one of the mould sections 202 to form the broad recesses and narrow supporting elements 70 on one side 40 of the blade 10 and blade material to project from the other side 50 of the blade 10 as in the embodiments of FIGS. 1 to 10. The protruding blade material formed on the other side of the blade can then be removed in a subsequent grinding step to produce the finished blade. In a variation of this method, the interior surfaces of the mould sections 202, 203 are shaped to define the external surface of the cutting blade 10 with the broad recesses 60 on both side surfaces 40, 50 of the blade 10, wherein for each recess 60 formed on one of the sides surfaces 40, 50 there is a corresponding protrusion 60a formed on the other side surface 40, 50 of the blade 10. Preferably, the recesses 60 and the protrusions 60a alternate, as in the blade 10 illustrated in FIGS. 12 and 14, such that in a subsequent grinding step, the protrusions 60a on both side surfaces 40, 50 of the blade 10 are ground away to leave broad recesses 60 on both sides surfaces 40, 50 of the blade separated by narrow supporting elements 70 within which the blade 10 has a greater thickness than the recesses 60 adjacent to each supporting element 70 and on either side 40, 50 of the blade 10.

Another near net manufacturing process that can be employed, that is not illustrated in the Figures, includes 3D printing. Various forms of 3D printing methods exist that could be employed in the present invention. 3D printing methods that could be employed include fused deposition modelling (FDM), electron beam freeform fabrication (EBF), direct metal laser sintering (DMLS), electron-beam melting (EBM), selective laser melting (SLM), selective laser sintering (SLS). In 3D printing processes, 3D printable models are created with a computer aided design (CAD) package in which geometric data is provided to the 3D printing apparatus. The 3D printing apparatus includes a computer processor that executed instructions produced from the geometric data to control an apparatus for reproducing the model represented by the geometric data in a layer by layer fashion until the final product is produced. The aforementioned 3D printing method enables knife blades with relatively complex forms to be produced such as the blade embodiments of FIGS. 1 to 10, 30 and 31.

In the abovementioned near net manufacturing processes minimal finishing is required to produce the finished knife blade. Preferably, the only finishing process required is grinding of the cutting edge 20 and forming the bevel 22. In the abovementioned embodiments that are illustrated with respect to the blade 10 of FIGS. 12 to 15, a final grinding step is employed to remove the protrusions 60a as well as to grind the cutting edge 20.

Those skilled in the art will appreciate that the invention described herein is susceptible to variations and modifications other than those specifically described. It is to be understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof

Future patent applications may be filed in Australia or overseas on the basis of or claiming priority from the present application. Features may be added to or omitted from the following claims at a later date so as to further define or re-define the invention or inventions.

1. A cutting blade comprising:
a cutting edge, a spine and opposite side surfaces,
a tapered portion of the blade extending longitudinally and adjacent to the cutting edge in which a thickness of the blade defined as a transverse distance between the opposite side surfaces tapers towards the cutting edge;
one or more broad recesses provided in one or more side surfaces of the blade, wherein at least one of the broad recesses is bounded at vertically opposite sides by the tapered portion and the spine and at longitudinally opposite sides by narrow supporting elements extending from the spine to the tapered portion.

2. The cutting blade of claim 1, wherein at least one of the recesses has a base in which the thickness of the blade is, at least in part, substantially the same or thinner than a maximum thickness of the blade at an adjoining portion of the tapered portion and that, at least in part, is thinner than a thickness of the blade at an adjoining portion of the spine.

3. The cutting blade of claim 2, wherein the base tapers substantially continuously with the adjoining portion of the tapered portion.

4. The cutting blade of claim 1, wherein at least one of the recesses includes a substantially planar base bounded by side surfaces upstanding from the base that adjoin the spine and the supporting elements.

5. The cutting blade of claim 4, wherein at least one of the recesses further includes a side surface upstanding from the base that adjoins the tapered portion.

6. The cutting blade of claim 4, wherein the sides define, at least in part, a boundary of the recess along, at least in part, substantially straight lines whereby the boundary is substantially polygonal.

7. The cutting blade of claim 6, wherein the boundary is defined, at least in part, along arcuate lines at which the substantially straight lines meet.

8. The cutting blade of claim 4, wherein the sides define, at least in part, a boundary of the recess along, at least in part, curved lines.

9. The cutting blade of claim 1, wherein at least one of the recesses is shallowest immediately adjacent the tapered portion and is deepest immediately adjacent the spine.

10. The cutting blade of claim 1, wherein both of the side surfaces of the blade include the broad recesses and the narrow supporting elements.

11. The cutting blade of claim 10, wherein the broad recesses and the narrow supporting elements on one of the side surfaces are substantially symmetrical with the broad recesses and the narrow supporting elements on the other side surface.

12. (canceled)

13. The cutting blade of claim 1, wherein at least one of the broad recesses has a vertical dimension in a direction from the cutting edge to the spine that is greater than a vertical dimension of either an adjoining portion of the tapered portion or an adjoining portion of the spine.

14. (canceled)

15. The cutting blade of claim 1, wherein at least one of the narrow supporting elements is an elongated rib.

16. The cutting blade of claim 15, wherein at least one of the elongated ribs tapers from a wider portion adjacent the tapered portion of the blade to a narrower portion adjacent the spine of the blade.

17. The cutting blade of claim 15, wherein at least one of the elongated ribs tapers from a wider portion adjacent the spine of the blade to a narrower portion adjacent the tapered portion of the blade.

18. The cutting blade of claim 1, wherein the elongated supporting elements are in the form of a plurality of fingers extending from the spine towards the tapered portion immediately adjacent the cutting edge of the blade with the recesses defined in spaces between adjacent pairs of the elongated supporting elements.

19. (canceled)

20. The cutting blade of claim 1, wherein at least one of the narrow supporting elements extends at an incline from the tapered zone to the spine.

21. The cutting blade of claim 16, wherein the incline is, at least in part, between 0 and 90 degrees or between 45 and 90 degrees from the tapered zone to the spine.

22. The cutting blade of claim 1, wherein one of the side surfaces includes a plurality of channels extending from the tapered portion to the spine.

23. The cutting blade of claim 21, wherein at least one of the channels has an open end at an edge of the blade adjoining the spine.

24-37. (canceled)
